(19) United States
(12) Patent Application Publication
(10) Pub. No.: US 2013/0031182 A1
(43) Pub. Date: Jan. 31, 2013

(54) RESOLVING AN EXCHANGE OF OBJECTS IN A COMMUNICATION NETWORK

(71) Applicants: Thomas R. Gross, Zurich (CH); Klaus Julisch, Bonstetten (CH); Matthias Schunter, Zurich (CH)

(72) Inventors: Thomas R. Gross, Zurich (CH); Klaus Julisch, Bonstetten (CH); Matthias Schunter, Zurich (CH)

(73) Assignee: International Business Machines Corporation, Armonk, NY (US)

(21) Appl. No.: 13/552,687

(22) Filed: Jul. 19, 2012

(30) Foreign Application Priority Data
Jul. 27, 2011 (EP) 11175501.3

(51) Int. Cl. G06F 15/16

(52) U.S. Cl. 709/205

(57) ABSTRACT

A method for resolving an exchange of a first object and a second object in a communication network. The first object is sent by a first entity to a second entity, the second object having been requested by the first entity from the second entity. A number of verifiers verify a transfer of the first object from the first entity, a number of trustees provide the second object or an equivalent to the second object. There are at least two verifiers or two trustees. Transfer verification is provided by at least one verifier. If the transfer of the first object from the first entity is verified, and a step of transferring the second objector the equivalent to the first entity by at least one trustee of the number of trustees based on the transfer verification.

### CROSS REFERENCE TO RELATED APPLICATION

The present invention claims priority under 35 U. S. C. 119 from European Patent Application Number 11175501.3, filed Jul. 27, 2011, the entire contents of which are incorporated herein by reference.

### BACKGROUND OF THE INVENTION

1. Field of the Invention

The present invention relates to a method and to a system for resolving an exchange of objects in a communication network, wherein a first object is sent by a first entity to a second entity and a second object is requested by the first entity from the second entity.

2. Description of Related Art

Certificates, particularly carbon certificates and payments are examples of objects which are exchanged over a communication network. Carbon certificates allow a company to produce a certain amount of carbon emissions. They are issued by the government or produced by companies that prevent corresponding or similar amounts of carbon emissions. By limiting the number of certificates that are issued, their cost increases which in turn acts as an incentive for reducing carbon emissions.

Usually, the environment of carbon certificate trading is very complex, with many parties involved: companies, local public authorities, multiple governments and their federal entities, of the buyer of the certificate as well as of the seller of the certificate. Thus, a single trusted third party (TTP) does not exist, nor can all dispute resolving authorities be trusted.

Ten patterns that frequently occur in emerging carbon markets are listed in Phishing, Bribery and Falsification: Combating the Complexities of Carbon Fraud, Published: Jun. 9, 2010 in Knowledge@Wharton (http://knowledge.wharton.upenn.edu/arlicle.cfm?articleid=2521). For example, in one such pattern an owner of a certificate uses it and then sells it nevertheless to unsuspecting buyers. Another similar pattern is selling the same certificate twice.

### BRIEF SUMMARY OF THE INVENTION

In accordance with one aspect of the present invention, a method is provided for resolving an exchange of a first object and a second object in a communication network in which the first object is sent by a first entity to a second entity and the second object is requested by the first entity from the second entity. The method includes the steps of: verifying a transfer of the first object from the first entity, using a number of verifiers; and providing either the second object or an equivalent to the second object, using a number of trustees. There must be at least two trustees or at least two verifiers. Further steps include verifying a transfer using at least one of the number of verifiers, if the transfer of the first object from the first entity is verified, and transferring the second object, or the equivalent thereof, to the first entity by at least one of the number of trustees based on the transfer verification.

According to a second aspect of the present invention, a system for resolving an exchange of a first object and a second object in a communication network, in which the first object is sent by a first entity to a second entity and the second object is requested by the first entity from the second entity, includes: a number of verifiers for verifying a transfer of the first object from the first entity; a number of trustees for providing the second object or an equivalent to the second object, there being at least two trustees or at least two verifiers; wherein at least one verifier is configured to provide a transfer verification, if the transfer of the first object from the first entity is verified; and wherein at least one trustee is configured to transfer the second object or the equivalent to the first entity based on the transfer verification.

### BRIEF DESCRIPTION OF THE DRAWINGS

FIG. 1 shows an embodiment of a sequence of method steps for resolving an exchange of objects in a communication network,

FIG. 2 is a schematic block diagram of a first embodiment of a system for resolving an exchange of objects in a communication network,

FIG. 3 is a schematic block diagram of a second embodiment of a system for resolving an exchange of objects in a communication network,

FIG. 4 is a schematic block diagram of a third embodiment of a system for resolving an exchange of objects in a communication network,

FIG. 5 is a schematic block diagram of a fourth embodiment of a system for resolving an exchange of objects in a communication network,

FIG. 6 shows an embodiment of a method for hierarchical exchange,

FIG. 7 shows an embodiment of a method for distributed fair exchange, and

FIG. 8 is a schematic block diagram of an embodiment of a system adapted for performing the method for resolving an exchange of objects in a communication network.

Similar or functionally similar elements in the figures have been allocated the same reference signs if not otherwise indicated.

### DETAILED DESCRIPTION OF THE EMBODIMENTS

According to an embodiment of a first aspect of the present invention, a method for resolving an exchange of a first object and a second object in a communication network is provided, the first object being sent by a first entity to a second entity and the second object being requested by the first entity from the second entity. The method has a step of providing a number of verifiers for verifying a transfer of the first object from the first entity, a step of providing a number of trustees for providing the second object or an equivalent to the second object, wherein the number of verifiers or the number of trustees is at least 2, a step of providing a transfer verification by at least one verifier of the number of verifiers, if the transfer of the first object from the first entity is verified, and a step of transferring the second object or the equivalent to the first entity by at least one trustee of the number of trustees based on the transfer verification.

The first object may be a certificate, for example a carbon certificate. The second object may be an associated monetary payment for that certificate. Of course, according to some implementations, the first object may be a payment and the second object may be a certificate which is to be received for that payment.

According to some implementations, fair exchange of the first and second objects is guaranteed, such that any transaction or exchange completes successfully or in a rewound state as if it did not occur. Thus, this property protects the involved parties, namely the first entity and the second entity, from any kind of adversarial behavior including double-spending.

By verifying the transfer of the first object from the first entity, any “recycle your carbon” pattern can be prevented. In particular, for above mentioned example of trading carbon certificates, by verifying the transfer from the first entity, for example a buyer, to a second entity, for example a seller, it is guaranteed that the buyer receives the certificate if and only if the transfer has been verified to be valid. If the seller tries to sell an invalid certificate, nothing happens since the verification fails.

Because the number of verifiers and/or the number of trustees is at least two, the present method is very robust also under complex trust and/or failure assumptions.

In an embodiment, a permissible subset of verifiers is selected from the number of verifiers, wherein the verifiers of the permissible subset jointly provide the transfer verification by verifying the transfer of the first object from the first entity.

A respective permissible subset of verifiers may be allocated to the respective entity, in particular to the first entity or the second entity.

For example, given a list of verifiers V and the set P(V) of all subsets of V, then the set of permissible verifiers is a given set PV [symbol] P(V). A simple concrete example could be: V={1,2}, P(V)={{},{1},{2},{1,2}}, PV={{1}, {1,2}}).

In a further embodiment, a tree structure of a plurality of second entities is provided, the tree structure having a parent second entity for each of the plurality of second entities, each parent second entity embodying one of the pluralities of verifiers and one of the plurality of trustees. For resolving the exchange, a resolution is recursively conducted between the first entity and one of the parent second entities in the tree structure.

Thus, the respective parent second entity may act as a trusted third party (TTP), particularly including a verifier and a trustee. Thus, a TTP tree structure may be established for global carbon certificate trading, for example.

In a further embodiment, if the resolving of the exchange fails with a parent second entity of a certain level in the tree structure, the resolution is recursively conducted by its parent second entity of a higher level in the tree structure.

In particular, the higher level is one level over the certain level in the tree structure. The resolution may include at least one resolving message, at least one resolution interaction, or a resolution protocol, e.g. including a number of resolving messages.

In a further embodiment, a further tree structure of a plurality of first entities is provided, the further tree structure having a parent first entity for each of the first entities, each parent first entity embodying one of the plurality of verifiers. For resolving the exchange, the resolution is conducted over its parent first entity to one of the parent second entities recursively.

In a further embodiment, if the resolving of the exchange fails with a parent second entity of a certain level in the tree structure, the resolution is recursively conducted by its parent second entity of a higher level over a parent first entity of a corresponding level in the further tree structure.

In a further embodiment, the tree structure and the further tree structure have corresponding levels of parent second entities and parent first entities, wherein, unless the exchange is resolved on a certain level of the corresponding levels, the resolution is escalated to a higher level over the certain level.

In a further embodiment, a first critical message is transmitted from the first entity to the second entity for initiating the exchange, wherein the first critical message includes or indicates the first object.

In a further embodiment, the resolving message includes the first critical message and an agreement for the exchange of the first and second objects, wherein the agreement is at least signed by the first entity and includes a first indication indicating the first object, a second indication indicating the second object and an escrowed second object.

In a further embodiment, the escrowed second object is de-escrowed by the parent second entity of the level in the tree structure resolving the exchange, wherein the de-escrowed second object is transmitted from that second parent entity to the first entity.

For example, the protocol uses payment escrow to enable recovery of a payment by third parties. The idea is to split a payment into two parts; the first part is sent first (the escrowed payment). This part allows a third party to initiate a payment. The second part is the actual payment. Such payment schemes are, e.g., described in reference Markus Jakobsson, Ripping Coins for a Fair Exchange, Department for Computer Science and Engineering, University of California, San Diego, La Jolla, Calif. 92093.

A simple implementation is an electronic check that requires a first signature of the payer to constitute an escrowed payment. A second signature from the payer, or the third party, then makes it valid for deposit.

In a further embodiment, at least one trustee of the number of trustees is allocated to a certain verifier of the number of verifiers, respectively, wherein a tree structure having structured levels for the plurality of verifiers is provided. For resolving the exchange, a resolving message is recursively escalated to a verifier of a higher level in the tree structure until the exchange is resolved.

A verifier and an allocated trustee may embody a TTP. Instead of using a single TTP, a number or plurality of TTPs is used which are arranged in a tree structure. In each level of the tree structure or hierarchy, the third parties may achieve a conclusion to the fair exchange and thus resolve the exchange. If not, each party may escalate to the next level in the tree structure and attempt to achieve a fair exchange on that higher level. This technique builds on the hope that on the way up the tree structure or hierarchy, two honest parties may be encountered that follow through with the fair exchange protocol execution and therefore resolve the exchange. Ultimately, at the top of the tree structure, a certain TTP is used again that resolves remaining disputes.

The above is explained in more detail with reference to the above mentioned example of trading carbon certificates between a seller and a buyer. Engaging in a fair exchange, seller and buyer may give any commitment material to the respective verifier parent. Then, the respective verifiers may lock the transfer and engage in an optimistic fair exchange on the hierarchy level. If they succeed, the fair exchange is completely successful and the exchange is resolved. If a dispute occurs, both parties may escalate the fair exchange to the respective parents, who proceed recursively in optimistic fair exchange.

In particular, the used protocol is optimistic in the sense that it assumes that in the vast majority of cases, the involved verifiers are honest and will follow the fair exchange protocol. For the dispute case, the fair exchange escalates towards the route of the tree structure keeping a tree of nested unresolved fair exchanges open.

The recursion fulfills a termination condition as the distance to the root decreases and the root is embodied as a TTP which is able to resolve fair exchange authoritatively.

In a further embodiment, the tree structure is provided with a parent verifier for each of the plurality of verifiers. For resolving the exchange, a resolving message is firstly transmitted from the first entity to a certain verifier allocated to the first entity, and, if the resolving fails with the certain verifier, the resolution is recursively conducted by the parent verifier of the certain verifier.

In a further embodiment, at least one trustee of the number of trustees is allocated to a certain verifier of the number of verifiers, respectively. For resolving the exchange, a resolution is conducted by the permissible subset of verifiers, wherein the verifiers of the permissible subset engage a predetermined consensus protocol for achieving a consensus for the exchange.

Before engaging the fair exchange, the first entity, for example seller, and the second entity, for example buyer, agree on a subset P(V) of the list of verifiers V for the present exchange. This may be enforced by regulations or drawn by random choice, for example.

In case of dispute, any commitment messages may be broadcasted to the verifiers of the agreed subset P(V) of verifiers.

In particular, the verifiers of the subset P(V) engage in a consensus protocol resistant against Byzantine Faults with the buyer and seller as clients. The consensus first establishes an agreement on the commitments and the lock of the corresponding resources, namely the first and second objects.

Once, the buyer and seller continued with payment and certificate trading, they broadcast these messages also to the verifiers of the subset P(V), which in turn reach consensus on the state of the fair exchange.

Finally, the verifiers of the subset P(V) reach consensus on the unlock of the certificate number and, thus, complete the fair exchange in a resolved transfer.

The number of messages in distributed fair exchange as described above may be quadratic or even cubic depending on the employed consensus protocol.

In a further embodiment, the consensus protocol is a Byzantine protocol or is based on a majority decision.

Any embodiment of the first aspect may be combined with any embodiment of the first aspect to obtain another embodiment of the first aspect.

According to an embodiment of a second aspect, the invention present invention relates to a computer program comprises including a program code for executing the method for resolving an exchange of a first object and a second object in a communication network according to the first aspect when run on at least one computer.

According to an embodiment of a third aspect, a system for resolving an exchange of a first object and a second object in a communication network is provided, the first object being sent by a first entity to a second entity and said the second object being requested by the first entity from the second entity. The system includes a number of verifiers and a number of trustees. The number of verifiers and/or the number of trustees is at least 2. Each verifier of the number of verifiers is configured to verify a transfer of the first object from the first entity. Each trustee of the number of trustees is configured to provide the second object or an equivalent to the second object. At least one verifier of the number of verifiers provides transfer verification, if the transfer of the first object from the first entity is verified. Further, at least one trustee of the number of trustees transfers the second object or the equivalent to the first entity based on the transfer verification.

The verifier may be any verifying means. Moreover, the trustee may be any means trusted by the first entity and the second entity.

The respective means may be implemented in hardware or in software. If the means are implemented in hardware, it may be embodied as a device, e.g. as a computer or as a processor or as a part of a system, e.g. a computer system. If the means are implemented in software it may be embodied as a computer program product, as a function, as a routine, as a program code or as an executable object.

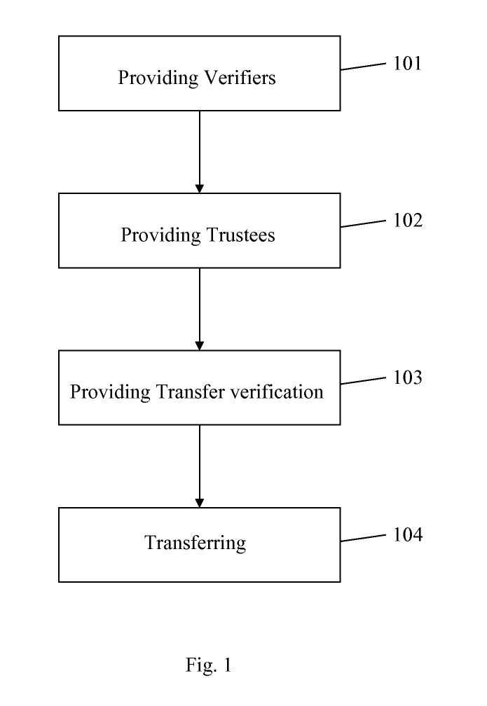

In FIG. 1, an embodiment of a sequence of method steps for resolving an exchange of objects in a communication network is depicted. The objects may be traded between a first entity and a second entity and may include a first object and a second object, wherein the first object is sent by the first entity to the second entity. Further, the second object is requested by the first entity from the second entity.

In step 101, a number of verifiers are provided. Each verifier of the number of verifiers is configured to verify a transfer of the first object from the first entity. In particular, the respective verifier may be configured to verify whether the transfer of the first object has succeeded.

In step 102, a number of trustees are provided. Each trustee of the number of trustees is configured to provide the second object or an equivalent to the second object.

The number of verifiers or the numbers of trustees is at least two. In particular, the number of verifiers is at least two and the number of trustees is at least two. The sequence of steps 101 and 102 may be changed.

In step 103, a transfer verification is provided or generated by at least one verifier of the number of verifiers, if the transfer of the first object from the first entity is verified.

In step 104, the second object or its equivalent is transferred to the first entity by the at least one trustee of the number of trustees. The transfer of the second object or its equivalent may be triggered by receiving the transfer verification as provided in step 103.

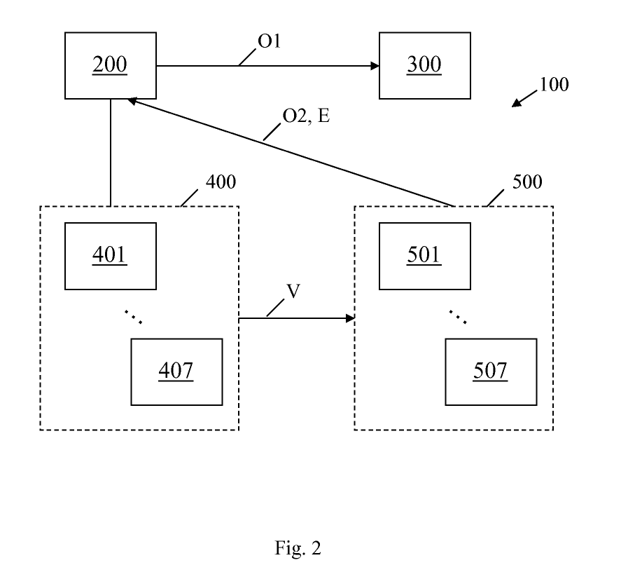

In FIG. 2 a schematic block diagram of a system 100 for resolving an exchange of objects O1, O2 in a communication network is illustrated. A first object O1 is sent by a first entity 200 to a second entity 300. A second object O2 which shall be transferred as reward for the first object O1 is requested by the first entity 200 from the second entity 300.

The system 100 includes a number 400 of verifiers 401-407 and a number 500 of trustees 501-507. Without loss of generality, the system 100 of FIG. 2 has seven verifiers 401-407 and seven trustees 501-507. Each verifier 401-407 is configured to verify a transfer of the first object O1 from the first entity 200. Further, each trustee 501-507 is configured to provide the second object O2 or an equivalent E to the second object O2. If the transfer of the first object O1 from the first entity 200 is verified by one of the verifiers 401-407, this verifier 401-407 provides a transfer verification V to one of the trustees 501-507. In particular, one trustee 501-507 is allocated to one certain verifier of the verifiers 401-407, respectively. For example, the trustee 501 is allocated to the verifier 401. In response to receiving the transfer verification V, the allocated trustee 501 transfers the second object O2 to the first entity 200. Alternatively to transferring the second object O2, the trustee 501 may transfer the equivalent E to the second object O2.

By receiving the second object O2 or its equivalent E by the first entity 200, the transfer of objects is resolved.

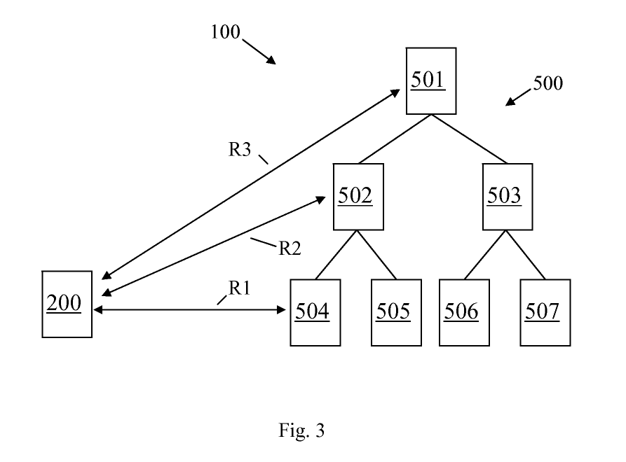

In FIG. 3, a schematic block diagram of a second embodiment of a system 100 for resolving an exchange of objects O1, O2 in a communication network is depicted. For illustration reasons, FIG. 3 shows only the resolution procedure between the first entity 200 and a plurality of second entities 501-507. In this embodiment of FIG. 3, the second entities 501-507 function as verifiers and trustees. Further, the second entities 501-507 are arranged in a tree structure 500. Each of the second entities 501-507 is a parent to another second entity. For example, the second entity 501 is a parent second entity for the second entities 502 and 503. Further, the second entity 502 is parent second entity for the second entities 504 and 505. Moreover, the second entity 503 is a parent second entity to the second entities 506 and 507. A parent second entity for the second entity 501 is not shown in FIG. 3. For example, there may be a higher-level second entity which may be the parent entity for this second entity 501. Moreover, the second entities 504 to 507 are parents to other second entities (not shown). Further, for resolving the exchange, a resolution R1-R3 is recursively conducted between the first entity 200 in one of the parent second entities 504, 502, 501 in the tree structure 500.

For example, in a first step for resolving the exchange, a resolution R1 is conducted between the first entity 200 and the second entity 504 being the parent second entity to that second entity with which the first entity 200 wants to trade.

For the example in FIG. 3, the resolving of the exchange fails with the second entity 504. As a result, a second step of resolution R2 is conducted between the first entity 200 and the parent second entity of the second entity 504. As shown in FIG. 3, the parent second entity for second entity 504 is the second entity 502. Thus, the second resolution R2 is conducted between the first entity 200 and the second entity 502. Moreover, also the second step of resolution R2 fails, so that a third step of resolution R3 is conducted between the first entity 200 and the second entity 501, which is the parent second entity for the second entity 502 which conducted the second step of resolution R2.

Before any resolution is necessary, a first critical message is transmitted from the first entity 200 to that second entity (not shown) with which the first entity 200 wants to exchange the first and second objects. The first critical message is configured to initiate the exchange of the first and second objects and includes or indicates the first object.

Any resolution R1-R3 may include at least one resolving message that includes the first critical message and an agreement for exchange of the first and second objects O1, O2. The agreement is at least signed by the first entity 200 and includes a first indication indicating the first object O1, a second indication indicating the second object O2 and an escrowed second object O2. The resolving message is escalated in the tree structure 500 with the resolutions R1-R3. The escrowed second object is de-escrowed by the second entity 501 which is the second entity of the tree structure 500 which actually resolves the exchange in the present example of FIG. 3. The de-escrowed second object is then transmitted from the second entity 501 to the first entity 200. This transfer may be part of the third resolution R3.

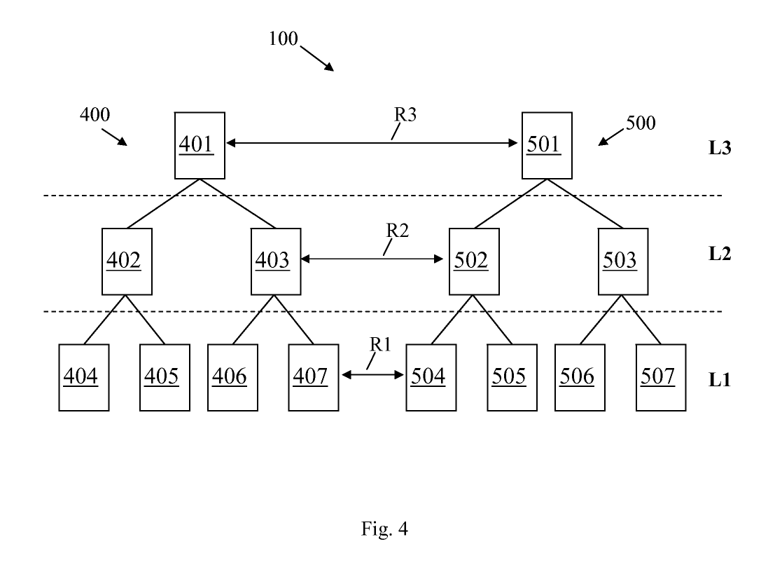

FIG. 4 shows a schematic block diagram of a third embodiment of a system 100 for resolving an exchange of objects in a communication network. The system 100 of FIG. 4 includes a tree structure 500, and a further tree structure 400. The tree structure 500 includes a plurality of second entities 501-507 and is structured as shown in FIG. 3, for example.

The further tree structure 400 has a plurality of first entities 401-407. Each of the first entities 401-407 is a parent to another first entity. Each parent first entity 401-407 embodies one of the plurality of verifiers.

The tree structure 500 has a plurality of second entities 501-507. Each of the plurality of second entities 501-507 is a parent to another second entity. Each parent second entity 501-507 embodies one of the plurality of trustees.

The further tree structure 400 and the tree structure 500 have corresponding levels L1-L3 of parent first entities 401-407 and parent second entities 501-507. First entities which are not parent to another first entity are not shown in FIG. 4. In an analogous way, second entities which are not parent to another second entity are not shown in FIG. 4. For example, the three levels L1-L3 as shown in FIG. 4 are hierarchically arranged. In general, unless the exchange is resolved on a certain level L1-L3, the resolution is escalated to a higher level over the certain level. For example, in a first step, a first resolution R1 is conducted between the first entity 407 and the second entity 504 in the first level L1. If this first resolution R1 fails, the resolution is escalated to a higher level, namely to level L2. Then a second resolution R2 is conducted between the first entity 403 and the second entity 502 in the second level L2. For the case that also the second resolution R2 fails, the resolution is escalated again to the higher level L3. In level L3, a third resolution R3 is conducted between the first entity 401 and the second entity 501, which is considered to be successful for this example.

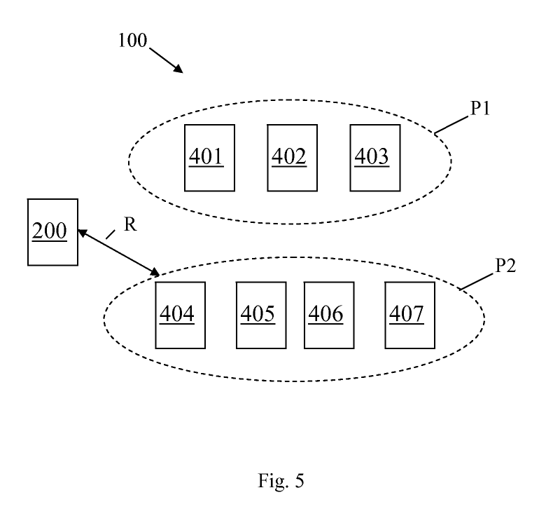

In FIG. 5, a schematic block diagram of a fourth embodiment of a system 100 for resolving an exchange of objects in a communication network is depicted. The system 100 of FIG. 5 has a first entity 200 which wants to purchase objects with a second entity (not shown in FIG. 5) which does not provide the requested second object. For resolving the exchange of the objects and in particular for providing the requested second object or its equivalent to the first entity 200, the system 100 has a first permissible subset P1 of verifiers 401-403 and a second permissible subset P2 of verifiers 404-407. Without loss of generality, FIG. 5 shows two permissible subsets P1, P2. And further, without loss of generality, the first permissible subset P1 has three verifiers 401-403, wherein the second permissible subset P2 has four verifiers 404-407. Further, it may be noted, that in the embodiment of FIG. 5, each verifier 401-407 includes a trustee. By way of example, the permissible subset of verifiers allocated to the example of the first entity 200 is the second permissible subset 502.

For resolving the exchange of the first and second objects, a resolution R is conducted by the second permissible subset P2 and the first entity 200. Then, the verifiers 404-407 of the permissible second subset P2 engage a predetermined consensus protocol for achieving a consensus for the exchange. Within that consensus, the second object or at least an equivalent of that second object is transferred from one of the verifiers 404-407 to the first entity 200.

In particular, the consensus protocol may be Byzantine protocol or may be based on a majority decision of the verifiers 404-407 of the allocated second permissible subset P2.

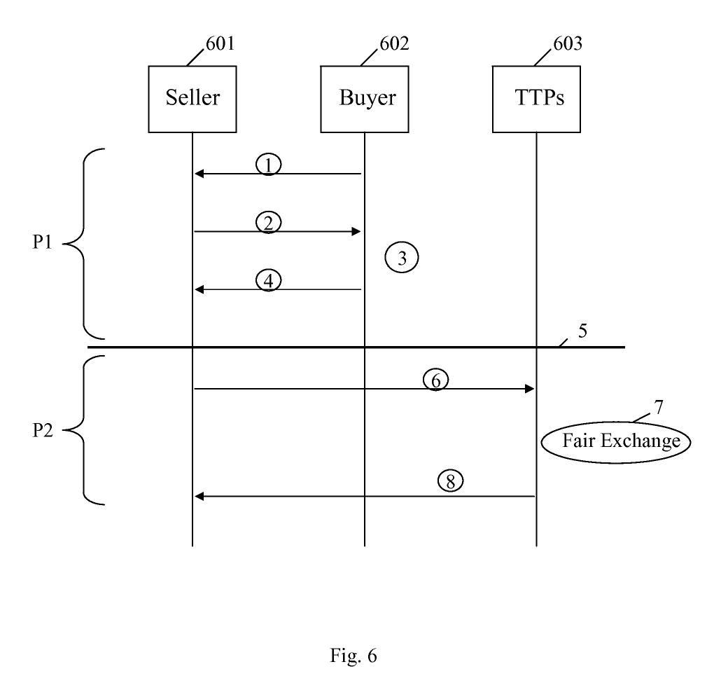

FIG. 6 shows an embodiment of a method for hierarchical exchange. The communication partners of FIG. 6 are a seller 601 selling a certificate, a buyer 602 buying the certificate and a plurality of TTPs 603, each TTP including a verifier and a trustee.

The protocol of FIG. 6 includes the transfer of messages and actions designated by reference signs 1-8. Further, the protocol of FIG. 6 is divided into an optimistic phase P1 and a recovery phase P2.

Starting with 1, the buyer 602 sends a signed agreement that he wants to exchange a certain certificate having a certain certificate number for a given payment. Further, the buyer 602 sends an escrowed payment that can be de-escrowed, i.e. make usable, by all other buyers in the hierarchy.

In 2, the seller 601 sends the certificate to the buyer 602. In 3, the buyer 602 validates the certificate. In 4, the buyer 602 sends the actual payment to the seller 601. Once, the seller 601 has received the payment, the protocol ends, which is designated by 5.

If the seller 601 does not receive any payment from the buyer 602, the recovery phase P2 of the protocol starts.

In 6, the seller 601 sends a resolving message to the TTPs 603. The resolving message may include a certificate number of the certificate provided to the buyer 602, and an agreement for the exchange of the certificate against a certain payment. The agreement is at least signed by the buyer 602 and includes a first indication indicating the certificate, a second indication indicating the payment and an escrowed payment.

In 7, an optimistic fair exchange is conducted by the TTPs 603. For example, the TTPs 603 may be structured as shown in FIG. 4.

In 8, the seller 601 receives the payment for the transferred certificate after a successful fair exchange.

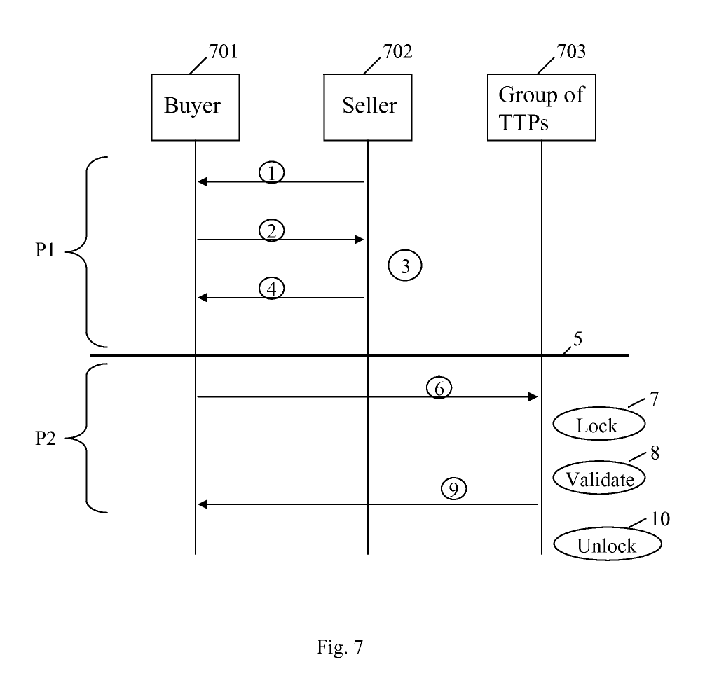

In FIG. 7, an embodiment of a method for distributed fair exchange is illustrated. The protocol of FIG. 7 has the communication partners buyer 701, seller 702 and a group of TTPs 703. In the protocol of FIG. 7, it is assumed that the payment message may be replayed to ensure that it has reached the seller 702. Further, an escrow for the certificate is used. As in FIG. 6, the protocol of FIG. 7 has an optimistic phase P1 and a recovery phase P2. The optimistic phase P1 of FIG. 7 works similar to the optimistic phase P1 of FIG. 6.

In 1, the seller 702 sends a signed agreement that he wants to exchange a certain certificate against a given payment. The seller 702 also sends an escrowed certificate that can be de-escrowed, i.e. make usable, by a quorum of the TTPs 703.

In 2, the buyer 701 sends the actual payment to the seller 702. In 3, the seller 702 validates the payment. In 4, the seller 702 sends the certificate to the buyer 701.

If the buyer 701 receives the certificate from the seller 701, the protocol ends which is designated by 5.

If the buyer 701 does not receive the certificate, the recovery phase P2 of the protocol starts.

In 6, the buyer 701 sends the payment and a signed agreement for trading the certain certificate against the associated payment to the group of TTPs 703.

In 7, the TTPs 703 perform a Byzantine agreement protocol to validate (see 8) that they agree on running the recovery phase P2 of the protocol for a given certificate number and to ensure the majority of TTPs 703 believes that the certificate is valid. If the TTPs 703 agree, they lock the certificate. In 9, the TTPs 703 send a copy of the certificate to the buyer 701. In 10, the TTPs 703 unlock the certificate to allow the buyer 701 to use it.

Computerized devices can be suitably designed for implementing embodiments of the present invention as described herein. In that respect, it can be appreciated that the methods described herein are largely non-interactive and automated. In exemplary embodiments, the methods described herein can be implemented either in an interactive, partly-interactive or non-interactive system. The methods described herein can be implemented in software (e.g., firmware), hardware, or a combination thereof. In exemplary embodiments, the methods described herein are implemented in software, as an executable program, the latter executed by suitable digital processing devices. In further exemplary embodiments, at least one step or all steps of above method of FIG. 1 may be implemented in software, as an executable program, the latter executed by suitable digital processing devices. In further exemplary embodiments, the determining step and the obtaining step of above method of FIG. 6 are implemented in software, in particular for the case that the duty cycle of the certain priority at the port is provided the that software. More generally, embodiments of the present invention can be implemented wherein general-purpose digital computers, such as personal computers, workstations, etc., are used.

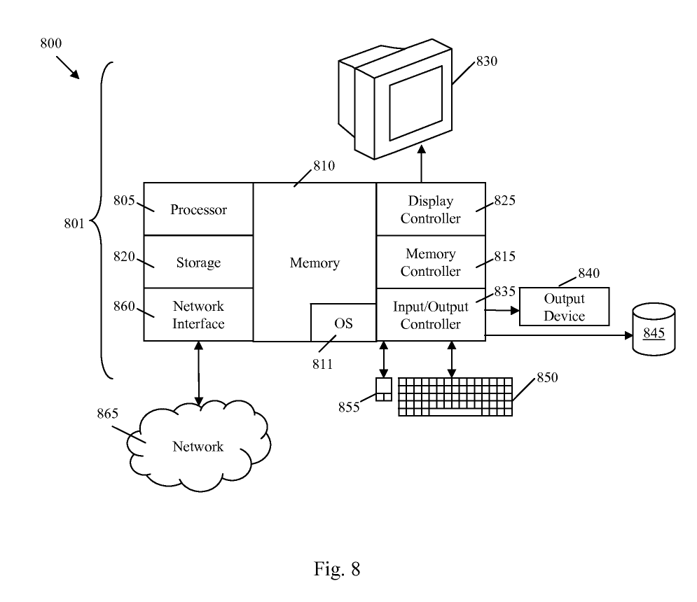

For instance, the system 800 depicted in FIG. 8 schematically represents a computerized unit 801, e.g., a general-purpose computer. In exemplary embodiments, in terms of hardware architecture, as shown in FIG. 8, the unit 801 includes a processor 805, memory 810 coupled to a memory controller 815, and one or more input and/or output (I/O) devices 840, 845, 850, 855 (or peripherals) that are communicatively coupled via a local input/output controller 835. The input/output controller 835 can be, but is not limited to, one or more buses or other wired or wireless connections, as is known in the art. The input/output controller 835 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 805 is a hardware device for executing software, particularly that stored in memory 810. The processor 805 can be any custom made or commercially available processor, a central processing unit (CPU), an auxiliary processor among several processors associated with the computer 801, a semiconductor based microprocessor (in the form of a microchip or chip set), or generally any device for executing software instructions.

The memory 810 can include any one or combination of volatile memory elements (e.g., random access memory) and nonvolatile memory elements. Moreover, the memory 810 may incorporate electronic, magnetic, optical, and/or other types of storage media. Note that the memory 810 can have a distributed architecture, where various components are situated remote from one another, but can be accessed by the processor 805.

The software in memory 810 may include one or more separate programs, each of which includes an ordered listing of executable instructions for implementing logical functions. In the example of FIG. 8, the software in the memory 810 includes methods described herein in accordance with exemplary embodiments and a suitable operating system (OS) 811. The OS 811 essentially controls the execution of other computer programs, such as the methods as described herein (e.g., FIG. 6), and provides scheduling, input-output control, file and data management, memory management, and communication control and related services.

The methods described herein may be in the form of a source program, executable program (object code), script, or any other entity including a set of instructions to be performed. When in a source program form, then the program needs to be translated via a compiler, assembler, interpreter, or the like, as known per se, which may or may not be included within the memory 810, so as to operate properly in connection with the OS 811. Furthermore, the methods can be written as an object oriented programming language, which has classes of data and methods, or a procedure programming language, which has routines, subroutines, and/or functions.

Possibly, a conventional keyboard 850 and mouse 855 can be coupled to the input/output controller 835. Other I/O devices 840- 855 may include sensors (especially in the case of network elements), i.e., hardware devices that produce a measurable response to a change in a physical condition like temperature or pressure (physical data to be monitored). Typically, the analog signal produced by the sensors is digitized by an analog-to-digital converter and sent to controllers 835 for further processing. Sensor nodes are ideally small, consume low energy, are autonomous and operate unattended.

In addition, the I/O devices 840-855 may further include devices that communicate both inputs and outputs. The system 800 can further include a display controller 825 coupled to a display 830. In exemplary embodiments, the system 800 can further include a network interface or transceiver 860 for coupling to a network 865.

The network 865 transmits and receives data between the unit 801 and external systems. The network 865 is possibly implemented in a wireless fashion, e.g., using wireless protocols and technologies, such as WiFi, WiMax, etc. The network 865 may be a fixed wireless network, a wireless local area network (LAN), a wireless wide area network (WAN) a personal area network (PAN), a virtual private network (VPN), intranet or other suitable network system and includes equipment for receiving and transmitting signals.

The network 865 can also be an IP-based network for communication between the unit 801 and any external server, client and the like via a broadband connection. In exemplary embodiments, network 865 can be a managed IP network administered by a service provider. Besides, the network 865 can be a packet-switched network such as a LAN, WAN, Internet network, etc.

If the unit 801 is a PC, workstation, intelligent device or the like, the software in the memory 810 may further include a basic input output system (BIOS). The BIOS is stored in ROM so that the BIOS can be executed when the computer 801 is activated.

When the unit 801 is in operation, the processor 805 is configured to execute software stored within the memory 810, to communicate data to and from the memory 810, and to generally control operations of the computer 801 pursuant to the software. The methods described herein and the OS 811, in whole or in part are read by the processor 805, typically buffered within the processor 805, and then executed. When the methods described herein (e.g. with reference to FIG. 1) are implemented in software, the methods can be stored on any computer readable medium, such as storage 820, for use by or in connection with any computer related system or method.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects. Furthermore, aspects of the present invention may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the unit 801, partly thereon, partly on a unit 801 and another unit 801, similar or not.

Aspects of the present invention are described above with reference to flowchart illustrations and/or block diagrams of methods, apparatus (systems) and computer program products according to embodiments of the present invention. It will be understood that each block of the flowchart illustrations and/or block diagrams can be implemented by one or more computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which includes one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved and algorithm optimization. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

More generally, while the present invention has been described with reference to certain embodiments, it will be understood by those skilled in the art that various changes may be made and equivalents may be substituted without departing from the scope of the present invention. In addition, many modifications may be made to adapt a particular situation to the teachings of the present invention without departing from its scope. Therefore, it is intended that the present invention not be limited to the particular embodiments disclosed, but that the present invention will include all embodiments falling within the scope of the appended claims.

1. A method for resolving an exchange of a first object and a second object in a communication network, said first object being sent by a first entity to a second entity and said second object being requested by the first entity from the second entity, the method comprising the steps of:
verifying a transfer of the first object from the first entity, using a number of verifiers;
providing an object selected from a group consisting of (i) the second object and (ii) an equivalent to the second object, using a number of trustees, wherein the number of trustees is at least two if the number of verifiers is not at least two,
verifying a transfer using at least one of the number of verifiers, if the transfer of the first object from the first entity is verified, and
transferring the second object, or the equivalent thereof, to the first entity by at least one of the number of trustees based on the transfer verification.

2. The method of claim 1, wherein:
a permissible subset of verifiers is selected from the number of verifiers, the verifiers of the permissible subset jointly providing the transfer verification by verifying the transfer of the first object from the first entity.

3. The method of claim 1, further including the step of:
providing a tree structure of a plurality of second entities, said tree structure having a parent second entity for each of the plurality of second entities, each parent second entity embodying one of the plurality of verifiers and one of the plurality of trustees, wherein, for resolving the exchange, a resolution is recursively conducted between the first entity and one of the parent second entities in the tree structure recursively.

4. The method of claim 3, wherein:
if the resolving of the exchange fails with a parent second entity of a certain level in the tree structure the resolution is recursively conducted by its parent second entity of a higher level in the tree structure.

5. The method of claim 3, further including the step of:
providing a further tree structure of a plurality of first entities, said further tree structure having a parent first entity for each of the first entities, each parent first entity embodying one of the plurality of verifiers, wherein, for resolving the exchange, the resolution is conducted over its parent first entity to one of the parent second entities recursively.

6. The method of claim 5, wherein:
if the resolving of the exchange fails with a parent second entity of a certain level in the tree structure, the resolution is recursively conducted by its parent second entity of a higher level over a parent first entity of a corresponding level in the further tree structure.

7. The method of claim 5, wherein:
the tree structure and the further tree structure have corresponding levels of parent second entities and parent first entities, wherein, unless the exchange is resolved on a certain level of the corresponding levels, the resolution is escalated to a higher level over the certain level.

8. The method of claim 7, wherein a first critical message is transmitted from the first entity to the second entity for initiating the exchange, wherein the first critical message includes or indicates the first object.

9. The method of claim 8, wherein the resolving message includes the first critical message and an agreement for the exchange of the first and second objects, wherein the agreement is at least signed by the first entity and includes a first indication indicating the first object, a second indication indicating the second object and an escrowed second object.

10. The method of claim 9, wherein the escrowed second object is de-escrowed by the parent second entity of the level in the tree structure resolving the exchange, wherein the de-escrowed second object is transmitted from that second parent entity to the first entity.

11. The method of claim 1, further including the steps of:
allocating at least one trustee of the number of trustees to a certain verifier of the number of verifiers; and
providing a tree structure having structured levels for the plurality of verifiers, wherein, for resolving the exchange, a resolving message is recursively escalated to a verifier of a higher level in the tree structure until the exchange is resolved.

12. The method of claim 11, wherein:
the tree structure is provided with a parent verifier for each of the plurality of verifiers; and
wherein, for resolving the exchange, a resolving message is first transmitted from the first entity to a certain verifier allocated to the first entity, and, if the resolving fails with the certain verifier, the resolution is recursively conducted by the parent verifier of the certain verifier.

13. The method of claim 2, further including the step of:
allocating at least one trustee of the number of trustees to a certain verifier of the number of verifiers, respectively; and
wherein, for resolving the exchange, a resolution is conducted by the permissible subset of verifiers, wherein the verifiers of the permissible subset engage a predetermined consensus protocol for achieving a consensus for the exchange.

14. The method of claim 13, wherein the consensus protocol is selected from the group consisting of a Byzantine protocol and a majority decision.

15. A system for resolving an exchange of a first object and a second object in a communication network, said first object being sent by a first entity to a second entity and said second object being requested by the first entity from the second entity, the system comprising:
a number of verifiers for verifying a transfer of the first object from the first entity;
a number of trustees for providing the second object or an equivalent to the second object, said number of trustees being at least two if the number of verifiers is not at least two;
wherein at least one verifier of the number of verifiers is configured to provide a transfer verification, if the transfer of the first object from the first entity is verified; and
wherein at least one trustee of the number of trustees is configured to transfer the second object or the equivalent to the first entity based on the transfer verification.
